(19) United States
(12) Patent Application Publication
(10) Pub. No.: US 2017/0343066 A1
(43) Pub. Date: Nov. 30, 2017

(54) Disc Brake And Components Thereof

(71) Applicant: Haldex Brake Products AB, Landskrona (SE)

(72) Inventor: Hans Welin, Sankt Ibb (SE)

(21) Appl. No.: 15/534,336

(22) PCT Filed: Dec. 8, 2015
(86) PCT No.: PCT/EP2015/079032

§ 371 Date: Jun. 8, 2017

(30) Foreign Application Priority Data
Dec. 8, 2014 (EP) 14196853.7

(51) Int. Cl. F16D 55/22; F16D 55/00

(52) U.S. Cl. CPC F16D 55/22; F16D 2055/0008; F16D 2055/002

(57) ABSTRACT

A disc brake and components thereof, in which a caliper or a carrier supporting such caliper and a connecting element being arranged on a wheel axle are in attachment with each other by inclined abutment surfaces.

### FIELD OF THE INVENTION

The present invention refers to a disc brake, preferably for utility vehicles, to a caliper for such a disc brake and to a carrier for such a caliper, and in particular to the way how a caliper or a carrier is fixed to a connecting element, which is arranged on a wheel axle.

### BACKGROUND OF THE INVENTION

A connecting element, also called torque plate, is arranged and fixed to the wheel axle of a vehicle in such a way that the caliper or carrier supporting such caliper of a disc brake can be mounted to the connecting element by means of mounting bolts, which are arranged to both sides of the wheel axle or the axis of the brake disc. For that purpose it is known to arrange the mounting bolts between the connecting element and the caliper or carrier in a direction in parallel to the axis of the brake disc and lateral thereto. By such arrangement, the torque, which may result from slightly different force relations between the disc-leading side and the disc-trailing side and which torque is basically orientated in a plane being perpendicular to the brake disc and extending between the mounting bolt sections to both sides of the axis of the wheel axle or brake disc, has to be taken up entirely by the friction between the torque plate and the caliper or carrier at their respective abutment surfaces.

Alternatively, the mounting bolts can be mounted radially so as to extend perpendicularly to the wheel axle. Such typical radial-mount type of disc brake according to the prior art is exemplarily shown in the perspective view of FIG. 1 and in the explosive view of FIG. 2.

The disc brake according to the prior art comprises a caliper 1 for receiving an actuation mechanism (not shown) and overlapping a brake disc 2. The caliper 1 is slideably supported on a carrier 3, which is bolted to a connecting element or torque plate 4. As can be seen from FIG. 2, the connecting element 4 is fixed to a wheel axle 5, so that the entire disc brake can be mounted on the wheel axle 5.

The connection between the connecting element 4 of the wheel axle 5 and the carrier 3 is realized by several mounting bolts 6, two of which are arranged to both sides of the wheel axle 5 and which each traverse through holes 7 in laterally arranged sections 8 of the connecting element 4, so as to become received by threaded blind holes 9 being arranged in corresponding lateral mounting sections 10 of the carrier 3, respectively. Thereby, flat abutment surfaces 11 of the carrier 3 do attach to flat abutment surfaces 12 of the connecting element 4, which abutment surfaces 11 and 12 are arranged parallel to a plane extending in and being parallel to the longitudinal direction of the wheel axle 5 or the axis of the brake disc 2 and extending between the mounting sections 10.

Further radial-mount type disc brakes are, e.g., known from EP 0 971 144 B1 and DE 100 63 787 A1.

When only flat abutment surfaces, which are perpendicularly arranged with respect to the brake disc do exist between the carrier or the caliper, in particular in case of a fixed-type caliper which will be directly mounted to the torque plate, and the torque plate, the afore-mentioned torque during braking, which causes that at the disc-leading side the caliper or carrier tends to rotate away from the brake disc while at the disc-trailing side the caliper or carrier tends to move towards the brake disc, leads to the effect that different forces from the friction between the flat abutment surfaces of the torque plate and the caliper or carrier have to be taken up by the mounting bolts on both sides of the brake disc axis. These effects become even larger when the mounting bolts are not tightened properly, which could happen during improper overhaul works.

Therefore, in such embodiments, for safety reasons, the mounting bolts have to be dimensioned large enough to take up such forces entirely. As a consequence, the lateral sections comprising the through holes for the mounting bolts at the torque plate on the one hand and the lateral mounting sections comprising the threaded openings for the mounting bolts at the caliper or carrier on the other have to be substantially dimensioned as well, which leads to larger carrier and/or caliper designs in this respect.

### SUMMARY OF THE INVENTION

Based on that it is the object of the present invention to provide an enhanced connection between a caliper or a carrier supporting a caliper and a connecting element or torque plate of a wheel axle, so as to enable more economic designs of these components of a disc brake.

Such object is solved by a disc brake according to embodiments of the invention and furthermore by a corresponding caliper for a disc brake according to an embodiment of the invention. Such object is also solved by a carrier for a caliper of a disc brake and by a connecting element (or torque plate) for a wheel axle according to embodiments of the invention.

The caliper or the carrier comprises at least one abutment surface, which does attach to at least one abutment surface of the connecting element, when the caliper or the carrier are fixed to the connecting element by means of several mounting bolts. According to the invention at least one abutment surface of said connecting element and at least one abutment surface of said caliper or said carrier, which abutment surfaces are in attachment which each other in at least a partly congruent manner, are defining an inclined plane, which intersects both a plane as defined by the brake disc in the idle mode and the axis of the brake disc. Thus, the abutment surfaces are inclined in relation to a plane extending in parallel and longitudinally to an axis of the wheel axle or the brake disc as well.

Since in some embodiments of calipers of the fixed type a brake disc is arranged to float on the wheel axle and thus could slightly tilt with respect thereto, it is noted that the plane of the brake disc, which is intersected by the inclined plane of the abutment surfaces, shall refer to the idle mode of the disc brake, which plane of the brake disc in such idle mode is clearly perpendicular to the axis of the brake disc or perpendicular to the plane as being defined longitudinally along such axis.

According to the invention, a further condition with respect to these abutment surfaces could be defined in such a way that these abutment surfaces shall be inclined against the orientation or direction of the vector of a torque, which torque results between the leading side and the trailing side of the brake disc during braking, i.e. when the brake pads do engage with the rotating brake disc.

Furthermore, according to the invention a still further condition with respect to these abutment surfaces could be defined so that the at least one abutment surface of the connecting element and the at least one abutment surface of the caliper or of the carrier shall be inclined in such a way so as to define a correspondingly inclined plane, which intersects both the plane, which extends in parallel and longitudinally to the axis of the wheel axle or of the brake disc and which plane is perpendicular to the plane being defined by the brake disc, and said plane of said brake disc, so that lines formed at the resulting intersections of these planes are parallel to each other, respectively.

The angle of inclination of the respective abutment surfaces could be selected deliberately depending on constructional and manufacturing needs. According to the invention the angle of inclination with respect to the plane being defined in parallel to the longitudinal direction or axis of the wheel axle or the brake disc could be in a range of 20 to 40 degrees, preferably in a range of 25 to 35 degrees and most preferably 30 degrees.

Due to the inclined abutment surfaces no friction forces between the torque plate and the carrier or caliper occur in the plane of the torque-induced rotational movement of the caliper or carrier upon braking, which plane is perpendicular to the plane of the brake disc when seen in the idle mode, as such turning forces resulting therefrom will be taken up entirely by the inclined abutment surfaces. At the same time, the mounting bolts will not be influenced by such friction and turning forces, so that with the presence of inclined abutment surfaces according to the invention mounting bolts could be employed, which can be dimensioned and selected to be smaller, accordingly.

Smaller mounting bolts go along with correspondingly smaller dimensioned support sections at the connecting element and mounting sections at the caliper or carrier, resulting further in a reduction of weight of and of manufacturing costs for the caliper, carrier or connecting element, respectively.

According to an embodiment of the invention, the connecting element or the torque plate comprises support sections at both sides of the wheel axle, which support sections both comprise inclined abutment surfaces. The mounting bolts do traverse the support sections and will be received in threaded openings, which are arranged in mounting sections of the caliper or the carrier, correspondingly, which mounting sections comprise abutment surfaces being congruently shaped and inclined in accordance with the inclined surfaces of the connecting element. For such embodiment, it is enough that only one accurate mounting bolt is tightly fit to provide some lateral control of the disc brake.

According to a further embodiment of the invention, only one support section on one side of the wheel axle comprises an inclined abutment surface. Correspondingly, the opposite mounting section of the caliper or the carrier comprises such inclined abutment surface. For this embodiment one accurate bolt comprises a preferably radial guiding surface to cooperate with a corresponding guiding surface in the mounting section of the caliper or carrier, so that the position of the torque plate or connecting element can be controlled in lateral direction. By that it is possible to arrange the mounting bolts slightly offset to each other, so that the carrier or caliper can be better adapted to constructional needs.

For both embodiments, the support sections could comprise said inclined abutment surfaces to both sides of the mounting bolts, when seen in the direction of the longitudinal axis of the wheel axle, which abutment surfaces are inclined in opposite directions with respect to each other. Accordingly, the mounting sections of the caliper or carrier comprise correspondingly shaped and inclined surfaces which do come into abutment with the inclined surfaces of the support sections, respectively.

According to yet another embodiment the support section on one side of the wheel axle could comprise a different height than the support section on the opposite side of the wheel axle. By that offset in height of the support section in relation to the opposite support section, it is ensured that calipers or carriers will not be mounted incorrectly.

According to another embodiment of the invention, at least one support section comprises a geometrically shaped element which corresponds with a correspondingly shaped element of the related mounting section of the caliper or carrier. Such geometrically shaped elements do form some kind of engagement mechanism between the connecting element and the carrier or the caliper, but having a large enough play so as to not hinder the assembly process, and could include different shapes, configurations and dimensions, e.g. such as steps, recesses, indents or similar. For example, steps could be arranged about halfway between the two mounting bolts of one support section.

The provision of such elements on both the support section of the torque plate and the corresponding mounting section of the carrier or caliper ensures that no incorrectly shaped caliper or carrier will be installed on the torque plate, which increases the safety during assembly. By that the corresponding caliper or carrier will always fit to the right connecting element or torque plate, which proves to be advantageous e.g. for overhaul works.

Further features and advantages become apparent from the description of the embodiments as shown in the enclosed drawings.

### BRIEF DESCRIPTION OF THE DRAWINGS

FIG. 1 is a perspective view of a disc brake being mounted on a wheel axle according to the prior art;

FIG. 2 is an explosive view of a carrier and a connecting element of such a disc brake according to the prior art;

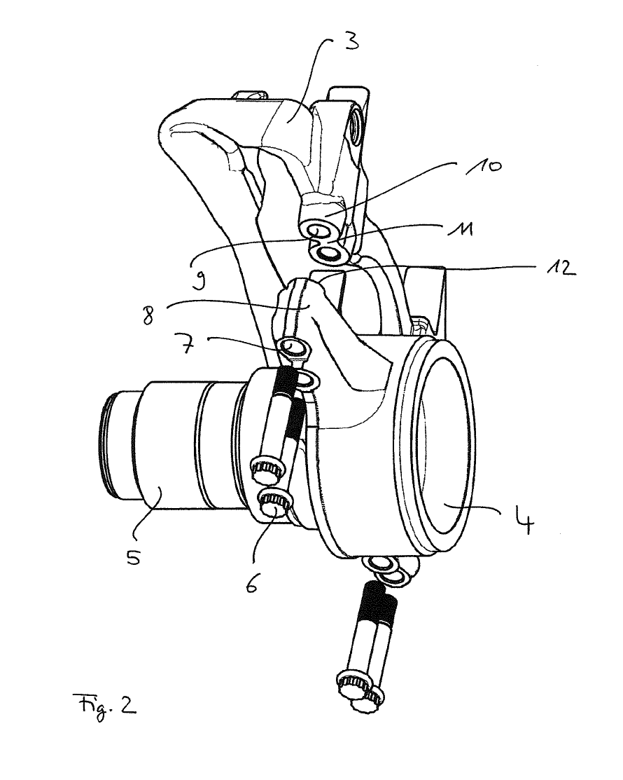

FIG. 3 is an explosive view of a first embodiment according to the invention showing a connecting plate on a wheel axle and a carrier;

FIG. 4 is an explosive view of a second embodiment according to the invention showing a connecting plate on a wheel axle and a carrier;

FIGS. 5a and 5b are cross-sections through a support section and mounting section of a connected carrier and torque plate;

FIG. 6 is a schematic sectional view of a third embodiment according to the invention showing a geometrically shaped element at the support section of the connecting element;

FIG. 7a schematically shows the orientation of the inclination of the abutment surfaces in relation to the torque resulting during braking; and

FIG. 7b schematically shows the position of intersecting lines between the different planes.

### DETAILED DESCRIPTION OF THE INVENTION

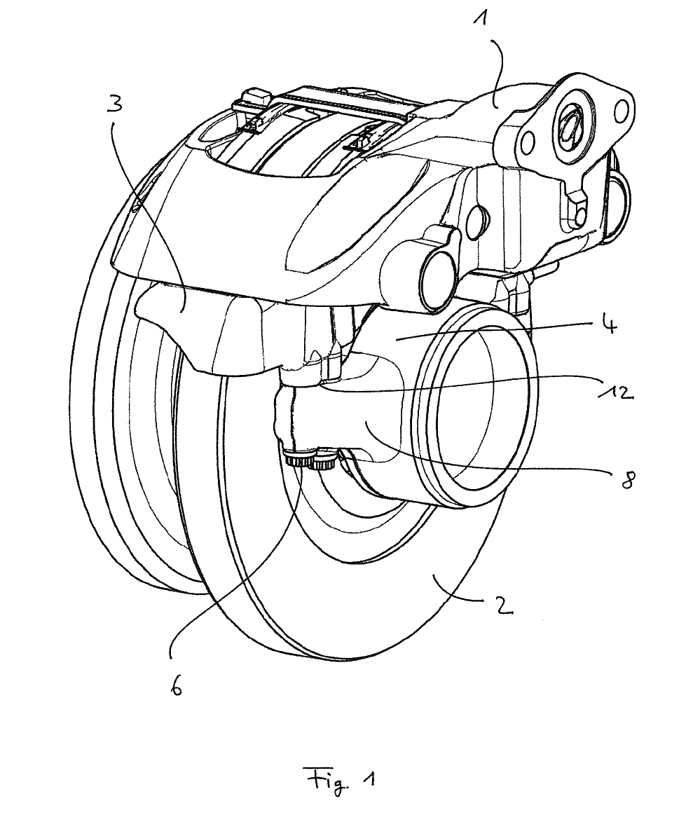

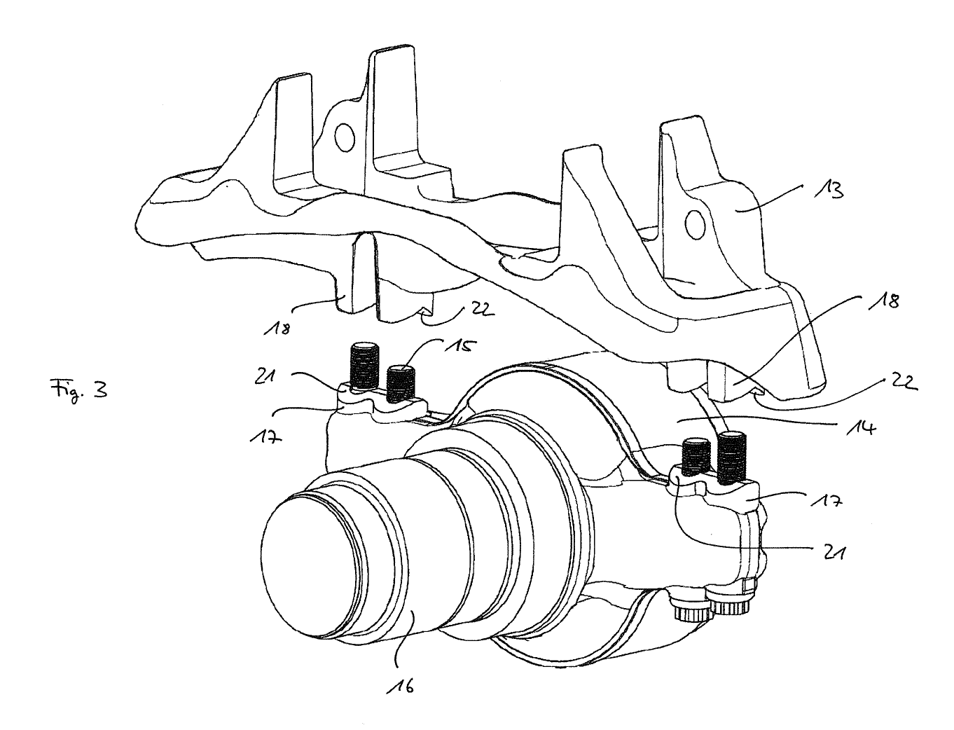

FIG. 3 shows a first embodiment of the invention in an explosive view. For ease of understanding the caliper with the brake actuation mechanism and the brake disc are not shown in the drawings, but their respective positions will become apparent from FIG. 1.

A carrier 13 for supporting a caliper overlapping a brake disc is to be mounted on a connecting element or torque plate 14 via four mounting bolts 15. The connecting element 14 is fixedly connected to a wheel axle 16.

The connecting element 14 comprises to both sides of the wheel axle 16 one support section 17, respectively. Accordingly, the carrier 13 comprises mounting sections 18 being arranged at corresponding lateral locations of it and extending towards the support sections 17 of the connecting element 14.

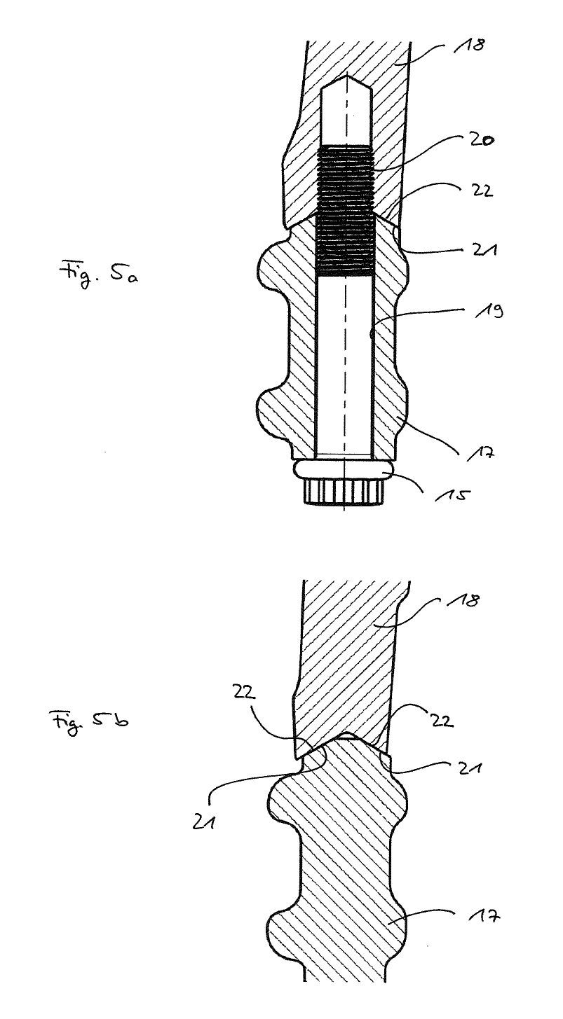

As can be seen in FIG. 5a, the support sections 17 comprise through holes 19 which receive the mounting bolts 15, whereas the mounting sections 18 of the carrier 13 comprise threaded openings or blind holes 20, into which the mounting bolts 15 will be fixedly inserted.

According to the invention, the support sections 17 comprise plane P abutment intersects both a plane Pose as defined by the brake disc and the axis W of the brake disc. The axis W of the brake disc actually corresponds to the axis of the wheel axle 16. The idle mode refers to the condition of the disc brake in which there is no engagement between the brake pads and the brake disc, thus the latter will be exactly orientated perpendicular to the axis W of the brake disc.

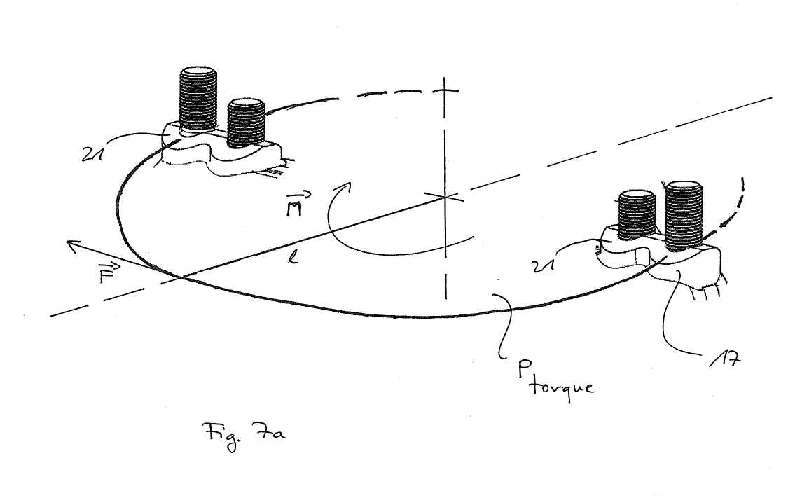

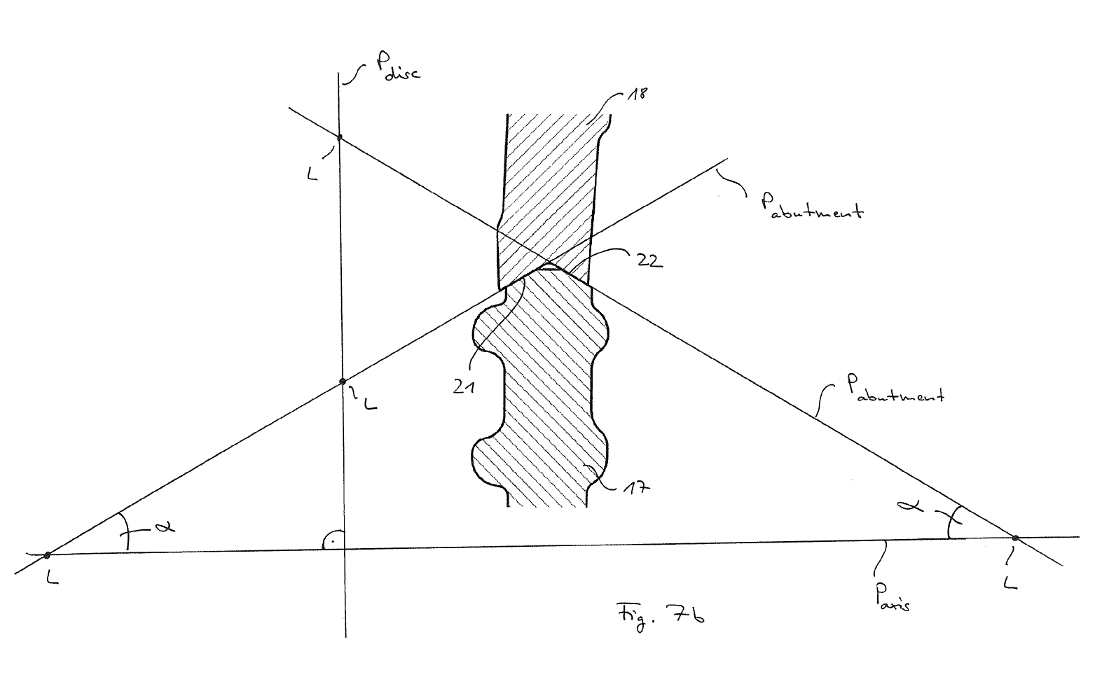

By that, as can be seen best in FIG. 7b, the inclination of the abutment surfaces 21 is thereby also directed towards a plane Pₐₓᵢₛ, which plane Pₐₓᵢₛ is defined in parallel to the longitudinal direction of axis W of the brake disc or of the wheel axle 16. Such inclination towards said plane Pₐₓᵢₛ is defined by an angle α.

In accordance thereto, the mounting sections 18 of the carrier 13 comprise inclined abutment surfaces 22, which are congruently inclined with respect to the inclination of the abutment surfaces 21 of the torque plate 14 by the same angle α, but orientated to the opposite.

As can be particularly seen in FIGS. 5a and b, the inclined surfaces 21 and 22 of both the support section 17 and of the mounting section 18 are provided at both sides of a symmetry line being defined by the mounting bolts 15, in which the inclination of the abutment surfaces 21 and 22 is directed towards each other so as to form some kind of wedge-like connection between the carrier 13 and the connecting element 14. The inclination to both sides of such symmetry line could be identical with an equal angle α or it could differ between both sides by corresponding differing angles.

The orientation of the inclination of the inclined abutment surfaces 21 and 22 according to the invention is explained further down below in detail with respect to FIG. 7a and FIG. 7b.

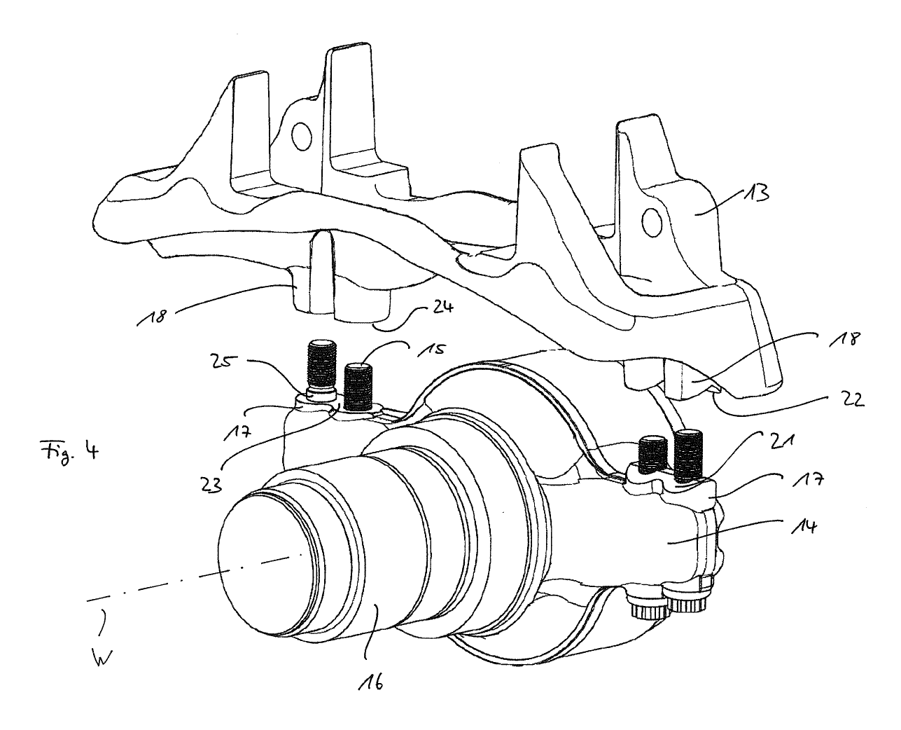

A further embodiment is shown in FIG. 4. According to this embodiment, only one support section 17 on one side of the wheel axle 16 comprises an inclined abutment surface 21, whereas the other support section 17 opposite of the wheel axle 16 comprises a flat abutment surface 23, which cooperates with a flat abutment surface 24 of the carrier 13.

It can be also seen from FIG. 4 that the support section 17 comprising the inclined abutment surface 21 is offset with respect to the height in relation to the support section 17 comprising the flat abutment surface 23.

The outer mounting bolt 15 in the support section 17 comprising the flat surfaces 23 comprises a radial guiding surface 25, which cooperates with a corresponding radial ring (not shown) in an opening of the corresponding mounting section 18 of the carrier 13. The guiding ring 25 serves to accurately guide the carrier 13 on the torque plate 14 laterally, i.e. traverse to the wheel axle 16.

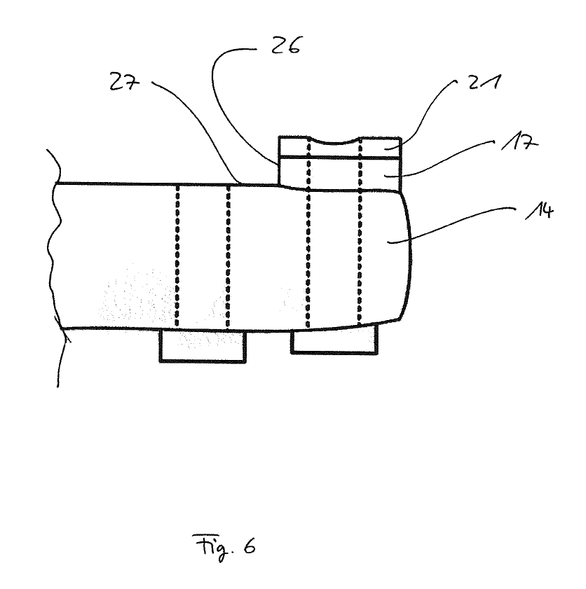

FIG. 6 schematically shows a sectional view of one side of the connecting element 14. The support section 17 comprises a step 26 which is arranged halfway between the two bolts (indicated by the dotted lines of the through holes), which step 26 will match with a correspondingly shaped step (not shown) of the related mounting section 18 of the carrier 13, so that the correct carrier 13 fits to the correct connecting element 14 in an accurate way. The abutment surface 27 relating to the inner mounting bolt 15 is thus flat. Mistakes during assembly can be avoided thereby. However, all kind of geometrically shaped elements, which allow matching between two components, could be used for that purpose.

FIG. 7a schematically shows the position of the support sections 17 to both sides of the wheel axle 16, wherein the carrier 13 and the torque plate 14 are omitted for better understanding.

When the brake pad engages with the brake disc during braking, the carrier 13 tends to be pushed away from the brake disc at the disc-leading side, while at the disc-trailing side the carrier 13 is pushed towards the brake disc, so that a torque M is generated, which acts in a plane P_{torque}, the plane P_{torque} being both parallel to the axis W of the brake disc (or wheel axle 16) and perpendicular to the plane P_{disc} as defined by the brake disc, when this plane P_{disc} is seen in the idle mode. The orientation of the torque M is such defined by the vector force F in relation to the vector lever I.

According to the invention, both the abutment surface 21 of the connecting element 14 and of the abutment surface 22 of the carrier 13 shall be inclined against the orientation of the vector of the torque M, which appears between the disc-leading side and the disc-trailing side, as can exemplarily be seen in FIG. 7a. Or in other words, the abutment surfaces 21, 22 are inclined against the tangential orientation of the force F relating to the torque M during braking, which torque M acts in the plane P_{torque} being perpendicular to the plane P_{disc} of the brake disc.

As an alternative, FIG. 7b schematically shows the inclination of the abutment surfaces 21 and 22 to be of such kind that these surfaces 21 and 22 each define one plane P_{abutment}, respectively, the planes P_{abutment} being inclined towards a plane Pₐₓᵢₛ being defined by the axis W of the brake disc (or of the wheel axle 16) by an angle α, which angle α actually defines the magnitude of the inclination of the abutment surface 21 and 22. The plane P_{disc} as being defined by the brake disc is perpendicular to the plane Pₐₓᵢₛ.

According to the invention the inclination of the abutment surfaces 21 and 22 by the angle α shall thus further be of such kind that the lines L, which are formed at intersections between the plane P_{abutment} and the plane P_{disc} on the one hand and between the plane P_{abutment} and the plane Pₐₓᵢₛ on the other are parallel to each other, respectively.

1. A disc brake comprising a caliper overlapping at least one brake disc and a connecting element being arranged on a wheel axle, the caliper being fixed to the connecting element by means of mounting bolts thereby abutment surfaces of said connecting element and abutment surfaces of said caliper are at least partly congruently attaching each other,
wherein at least one abutment surface of said connecting element and at least one abutment surface of said caliper, which abutment surfaces are attaching each other, are defining an inclined plane, which intersects both a plane as defined by the brake disc in the idle mode and the axis of the brake disc.

2. A disc brake comprising a caliper overlapping at least one brake disc, a carrier supporting the caliper, and a connecting element being arranged on a wheel axle, the carrier being fixed to the connecting element by means of mounting bolts thereby abutment surfaces of said connecting element and abutment surfaces of said carrier are at least partly congruently attaching each other,
wherein at least one abutment surface of said connecting element and at least one abutment surface of said carrier, which abutment surfaces are attaching each other, are defining an inclined plane, which intersects both a plane as defined by the brake disc in the idle mode and the axis of the brake disc.

3. The disc brake of claim 1, wherein the abutment surfaces are inclined against the orientation of the vector of a torque resulting between the leading side and the trailing side of the brake disc during braking.

4. The disc brake of claim 1, wherein the inclined plane intersects both a plane, which extends in parallel and longitudinally to said axis of said brake disc and which is perpendicular to said plane being defined by the brake disc, and said plane of the brake disc, so that lines formed at the intersections of the planes are parallel to each other, respectively.

5. The disc brake of one of claim 1, wherein the connecting element comprises support sections on both sides of the wheel axle, which support sections are being traversed by said mounting bolts, in which at least one support section on one side of the wheel axle comprises an inclined abutment surface.

6. The disc brake of claim 5, wherein the support section on one side of the wheel axle comprises a different height than the support section on the opposite side of the wheel axle.

7. The disc brake of claim 5, wherein the support sections comprise said inclined abutment surfaces to both sides of the mounting bolts in the direction of the longitudinal axis of the brake disc, which abutment surfaces are inclined in opposite directions.

8. The disc brake of claim 5, wherein at least one support section comprises a geometrically shaped element which matches with a correspondingly geometrically shaped element of the caliper or carrier.

9. The disc brake of one of claim 1, wherein an angle of inclination of the inclined plane of the abutment surfaces is in a range of 20 to 40 degrees, in relation to said axis of the brake disc.

10. A caliper of a disc brake for receiving a brake disc, the caliper comprising mounting sections to both sides of the axis of the brake disc, which mounting sections are adapted to attach to support sections of a connecting element of a wheel axle,
wherein at least one mounting section comprises an abutment surface, which defines an inclined plane, which intersects both a plane as defined by the brake disc in the idle mode and said axis of the brake disc.

11. The caliper of claim 10, wherein the mounting section comprises at least one geometrically shaped element which is adapted to match with a correspondingly geometrically shaped element of a support section of said connecting element.

12. A carrier for supporting a caliper of a disc brake for receiving a brake disc, the carrier comprising mounting sections to both sides of the axis of the brake disc, which mounting sections are adapted to attach to support sections of a connecting element of a wheel axle,
wherein at least one mounting section comprises an abutment surface, which defines an inclined plane, which intersects both a plane as defined by the brake disc in the idle mode and said axis of the brake disc.

13. The carrier of claim 12, wherein the mounting section comprises at least one geometrically shaped element which is adapted to match with a correspondingly geometrically shaped element of a support section of said connecting element.

14. A connecting element of a wheel axle for mounting a carrier or caliper of a disc brake to the wheel axle, the wheel axle comprising at least one brake disc and the connecting element comprising support sections at both sides of the axis of the brake disc, which support sections are adapted to attach to mounting sections of the carrier or the caliper,
wherein at least one support section comprises an abutment surface, which defines an inclined plane, which intersects both a plane as defined by the brake disc in the idle mode and the axis of the brake disc.

15. The connecting element of claim 14, wherein the support section on one side of the wheel axle comprises a different height than the support section on the other side of it.

16. The connecting element of claim 14, wherein at least one support section comprises a geometrically shaped element which is adapted to match with a correspondingly geometrically shaped element of said caliper or said carrier.

17. The connecting element of claim 14, in which the connecting element is integral with the wheel axle.

18. The disc brake of claim 9, wherein an angle of inclination of the inclined plane of the abutment surfaces is in a range of 25 to 35 degrees in relation to said axis of the brake disc.

19. The disc brake of claim 9, wherein an angle of inclination of the inclined plane of the abutment surfaces is 30 degrees in relation to said axis of the brake disc.
